(19) United States
(12) Patent Application Publication
(10) Pub. No.: US 2010/0323615 A1
(43) Pub. Date: Dec. 23, 2010

(54) Security, Safety, Augmentation Systems, And Associated Methods

(76) Inventors: Curtis A. Vock, Niwot, CO (US); Perry Youngs, Longmont, CO (US)

Correspondence Address: LATHROP & GAGE LLP, 4845 PEARL EAST CIRCLE, SUITE 201, BOULDER, CO, 80301, US

(21) Appl. No.: 12/818,044

(22) Filed: Jun. 17, 2010

Related U.S. Application Data
(60) Provisional application No. 61/218,798, filed on Jun. 19, 2009.

(51) Int. Cl. H04W 88/02; H04W 24/00; G10L 15/00

(52) U.S. Cl. 455/26.1; 455/556.1; 704/231; 704/E15.001

(57) ABSTRACT

A mobile device has a datalog module that captures multimedia data at the mobile device and transmits the multimedia data through cell networks to a control center. The mobile device may also include a GPS sensor wherein location information is included within the multimedia data. A mobile device has a motion module that, when activated at the mobile device or through a cell network, disables communications through the mobile device when in motion. A system disables operation of a mobile device by a vehicle operator and includes a transmitter within the vehicle that generates a disabling signal that, when received by a safety receiver within the mobile device, disables operation of the mobile device. A mobile device has a microphone, and a voice augmentation module which is selectively activated to augment voice data spoken into the mobile device, by removing background noise and/or replacing or changing voice data.

### RELATED APPLICATIONS

This application claims priority to U.S. Provisional Patent Application Ser. No. 61/218,798, filed Jun. 19, 2009, which is incorporated herein by reference.

### BACKGROUND

Mobile phones are of course very popular. The use of a mobile phone can provide safety, but also invite danger. For example, in the event of emergency, a mobile phone can be used to call for help. It is also known that a mobile phone can be located using triangulation (or GPS coordinates) to locate a user that may be in danger or incapacitated. At the same time, a mobile phone can be used while operating a vehicle, creating danger for the driver or others if the driver becomes distracted.

Also, it is difficult to communicate through a mobile phone with extraneous noises occurring around the mobile phone user (for example, mobile phone users are often in public areas that add to the user's voice, making the voice difficult to interpret).

### SUMMARY

In one embodiment, a mobile device has a microphone, a digital camera, a voice recognition module for determining whether a voice command is spoken into the microphone, and a datalog module for capturing and off-loading multimedia data from the microphone and digital camera when activated by the voice command.

In another embodiment, a mobile device has a sensor for generating a trigger, and a datalog module which, when triggered, captures multimedia data at the mobile device and transmits the multimedia data through cell networks to a control center.

In another embodiment, a system augments safety of a user of a mobile device. A mobile device has a microphone and one or more of a GPS sensor and a digital camera. A datalog module is activated by voice or a trigger to capture data from the microphone, the GPS sensor and the digital camera, and the data is wirelessly offloaded from the mobile device. A remote data storage is accessible through the Internet to review the data.

In another embodiment, a mobile device has a motion module which, when activated at the mobile device or through a cell network, disables communications through the mobile device when the mobile device is in motion.

In another embodiment, a mobile device has a microphone, and a voice augmentation module which is selectively activated to augment voice data spoken into the mobile device, by (a) removing background noise and/or (b) replacing or changing voice data.

In another embodiment, a system augments voice communication between a mobile device and a communication port. A voice augmentation module located within a service provider of the mobile device is selectively activated to augment voice data spoken into the mobile device, by (a) removing background noise and/or (b) replacing or changing voice data.

In another embodiment, a system disables operation of a mobile device by an operator of a vehicle. The system includes a transmitter within the vehicle for generating a disabling signal, an antenna coupled with the transmitter for transmitting the disabling signal proximate the operator of the vehicle, and a safety receiver within the mobile device for receiving the disabling signal and disabling, at least in part, operation of the mobile device.

In another embodiment, a mobile device has a microphone and at least one additional device selected from the group of a digital camera and a GPS sensor; and a datalog module which, when activated, captures data from the microphone and additional device and off-loads the data to remote data storage.

### BRIEF DESCRIPTION OF THE DRAWINGS

FIG. 1A shows one exemplary mobile device with a voice augmentation module, in an embodiment.

FIG. 1B shows a system similar to FIG. 1A, wherein a voice augmentation module is included within a service provider that provides communication services, in an embodiment.

FIG. 2 is a flow chart illustrating activation and then operation of the voice augmentation module within the mobile device of FIG. 1A.

FIG. 3 is a schematic block diagram of one exemplary mobile device with data off-load security, in an embodiment.

FIG. 4 is a flow chart illustrating exemplary operation of the mobile device of FIG. 3.

FIG. 5 is a schematic block diagram of one exemplary mobile device with motion module, in an embodiment.

FIG. 6 is a flow chart illustrating exemplary operation of the mobile device of FIG. 5.

FIG. 7 shows one exemplary system for disabling operation of a mobile device while driving a vehicle, in an embodiment.

FIG. 8 schematically shows the mobile device of FIG. 7, illustrating a safety receiver, in an embodiment.

### DETAILED DESCRIPTION OF THE EMBODIMENTS

Voice disguise software (also known as voice camouflage or voice change software) is known. See, e.g., AV Voice Changer Software 7.0 and Voice Twister software by Screaming Bee. Voice Twister software morphs a person's voice on Windows based mobile devices for entertainment purposes. MorphVOX™ Pro, software also by Screaming Bee, additionally provides voice background suppression and voice morphing capability.

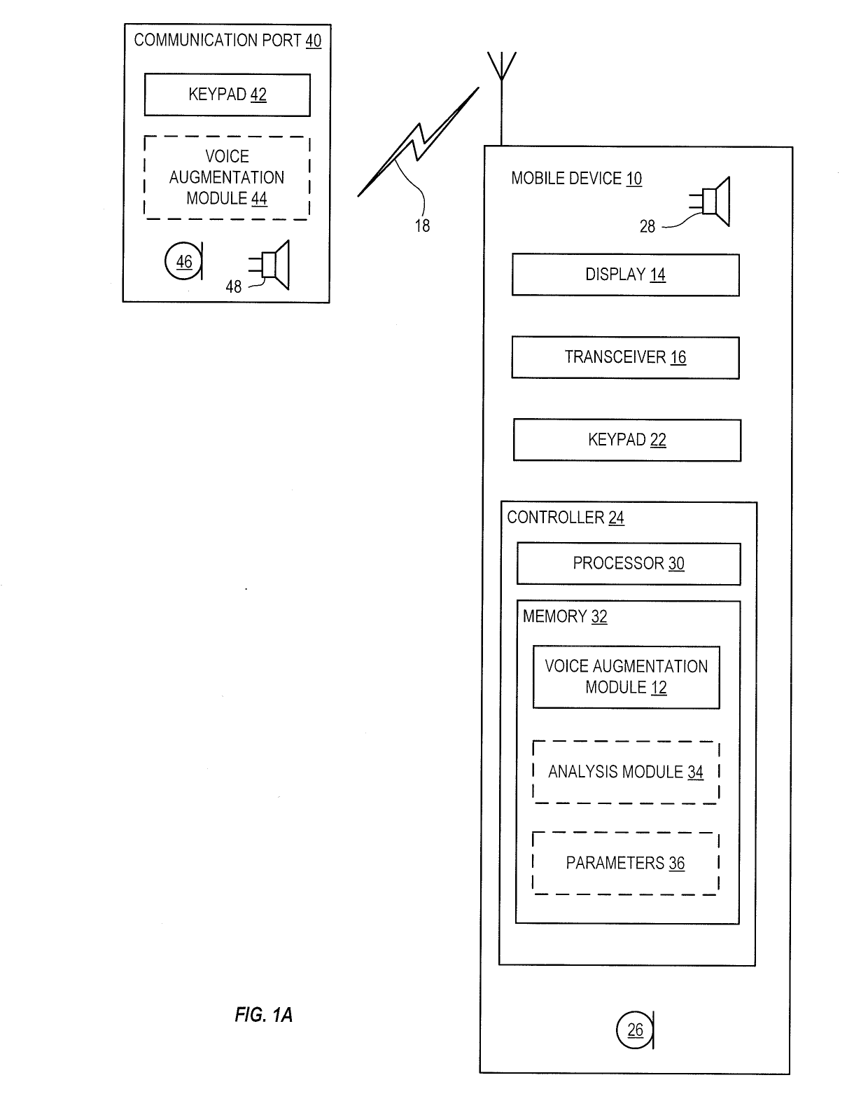

FIG. 1A shows one exemplary mobile device 10 with a voice augmentation module 12. Mobile device 10 may represent one or more of a mobile phone, a Smartphone, a reader device, a mobile computer (e.g., a laptop computer), and other such devices that have communication capability, such as voice data, SMS data, and Internet traffic. Mobile device 10 is also illustratively shown with (a) a display 14, which displays data and information about phone calls to and from mobile device 10, (b) a transceiver 16, which facilitates wireless communications 18 (e.g., voice data) between mobile device 10 and another phone or computer (such phone or computer is shown generally as communication port 40), (c) a keypad 22, which provides a user interface for mobile device 10, and (d) a controller 24, which provides overall control of mobile device 10. Controller 24 is shows as including a processor 30 and a memory 32. In an embodiment, voice augmentation module 12 is implemented in firmware as a software module comprising instructions executed by processor 30. In an alternate embodiment, voice augmentation module 12 is implemented as hardware. Within mobile device 10, a microphone 26 captures voice input from a user of mobile device 10 (this voice input is converted to voice data 18 communicated to a communication port 40), while a speaker 28 provides audible output (e.g., voice data 18 from communication port 40) to the user. Similarly, a microphone 46 captures voice input from person(s) at communication port 40 (this voice input is converted to voice data 18 communicated to mobile device 10), while a speaker 48 provides audible output (e.g., voice data 18 delivered from mobile device 10) to these person(s). A keypad 42 at communication port 40 may also be used by such person(s) to send control signals to mobile device 10, as described below.

In an embodiment, voice augmentation module 12 is activated by user operation of keypad 22. Activation may be selected, using different keys of keypad 22, for (a) outgoing voice data, (b) incoming voice data, or (c) both incoming and outgoing voice data. Once activated by keypad 22, voice augmentation module 12 operates to alter the selected (incoming and/or outgoing) voice data by (i) removing background noise and/or by (ii) changing or replacing (changing or replacing hereinafter referred to as “augmenting”) voice data (for example from one frequency range to another) while preserving the informational content of the voice data.

For example, consider the situation where a user of mobile device 10 is in a noisy environment and yet has to make an important business phone call overseas. The goal of the phone call is for the user to speak into microphone 26 and have the people at communication port 40 hear his voice clearly through speaker 48 and, conversely, that the user clearly hears, through speaker 28, the voices of the people speaking into microphone 46. While the concept is simple, too many times the phone call is, for one party or both, very difficult to hear. Realizing that the environment is noisy is a concern because people residing at the overseas location (i.e., at communication port 40, in this example) will hear all the background noise too, through speaker 48, possibly destroying the value of the phone call. In this situation, the user (in an embodiment) activates voice augmentation module 12 using keypad 22 and removes background noises from voice data 18. Voice data is for example 300-3400 Hz, whereas music and other background noises may have much broader ranges that can be eliminated through processing by voice augmentation module 12. If the background noises are other voices, however, such removal may be insufficient since background voices may continue to transmitted as voice data 18. Therefore, in an embodiment, voice augmentation module 12 may be tuned to the user of mobile device 10 (as a basic example, adult males typically have a fundamental frequency of 85-155 Hz while adult females have a fundamental frequency of 165-255 Hz) so that external background voices may be rejected and removed from voice data 18 when the user speaks into microphone 26. Or, at the selection of the user at keypad 22, voice augmentation module 12 may completely change (in another embodiment) the voice of the user to a preselected voice (e.g., a preselected computer voice that suits the listeners at communication port 40; such a preselected computer voice is, illustratively, pleasing and easy-to-understand, such as the on-board ship computer voice used in Star Trek®).

At the same time or alternatively, the same user can select, at keypad 22, to augment voice data 18 received from communication port 40. For example, the user may “hear better” in a different frequency range, and so selects another preprogrammed voice to relay voice data 18 from persons speaking into microphone 46. In a simple example, a man with a foreign accent may be speaking into microphone 46 at communication port 40, but the user of mobile device 10 hears this man as a woman with an American accent, if voice augmentation module 12 is so commanded via keypad 22.

In another embodiment, voice activation module 12 is activated by control signals initiated at communication port 40, for example by using keypad 42. Voice augmentation module 12 may be tuned to the user of mobile device 10 so that external background voices may be rejected and removed from voice data 18 when the user speaks into microphone 26. Or, at the selection of the person using keypad 42, voice augmentation module 12 may completely change (in another embodiment) the voice of the user of mobile device 10 to a preselected voice (e.g., a preselected computer voice that suits the listeners at communication port 40; such a preselected computer voice is for example pleasing and easy-to-understand, such as the on-board ship computer voice used in Star Trek®).

At the same time or alternatively, the same person at communication port 40 can select, at keypad 42, to augment voice data 18 received from mobile device 10. For example, the person may “hear better” in a different frequency range, and so selects another predetermined voice to relay voice data 18 from the user of mobile device 10 speaking into microphone 26. In a simple example, a man with a foreign accent may be speaking into microphone 26 at mobile device 10, but the person at communication port 40 hears this man as a woman with an American accent, if voice augmentation module 12 is so commanded via keypad 42.

Optionally, mobile device 10 also includes an analysis module 34 that analyzes voice data captured by microphone 26 under favorable conditions (e.g., in a quiet environment) to determine characteristics of that voice. Analysis module 34 then outputs parameters 36 that define operation of voice augmentation module 12, for example to enhance quality of voice data 18 when removing background noise. In one example of operation, analysis module 34 is used by a person with a voice with frequencies outside the telephone transmission frequency range for voice. Analysis module 34 defines parameters 36 that modify frequencies within the user's voice to enhance the experience of the listener (e.g., at communication port 40).

Optionally, communication port 40 also includes a voice augmentation module 44 that operates under control of keypad 42 to modify voice input of microphone 46 for transmission as voice data 18, and/or modified voice data 18 for output on speaker 48. An analysis module 34 may also be included within port 40 to produce parameters 36 similarly, in an embodiment.

FIG. 1B shows, in an alternate embodiment, a system similar to FIG. 1A, wherein a voice augmentation module 52 is included within a service provider 50 that provides communication services to mobile device 10 and communication port 40. Control of voice augmentation module 52 is similarly provided by keypad 22 and/or keypad 42 of mobile device 10 and/or communication port 40, respectively. That is, voice augmentation module 52 is activated by user operation of keypad 22 and/or activation by a user operating keypad 42 at communication port 40. Activation may be selected, using different keys of keypads 22 and 42, for (a) outgoing voice data, (b) incoming voice data, or (c) both incoming and outgoing voice data. Once activated by one or both of keypads 22 and 42, voice augmentation module 52 operates to alter the selected (incoming and/or outgoing) voice data by (i) removing background noise and/or by (ii) changing or replacing (changing or replacing hereinafter referred to as “augmenting”) voice data (for example from one frequency range to another) while preserving the informational content of the voice data. Service provider 50 may additionally include functionality similar to analysis module 34 to produce parameters 36 automatically, in an embodiment.

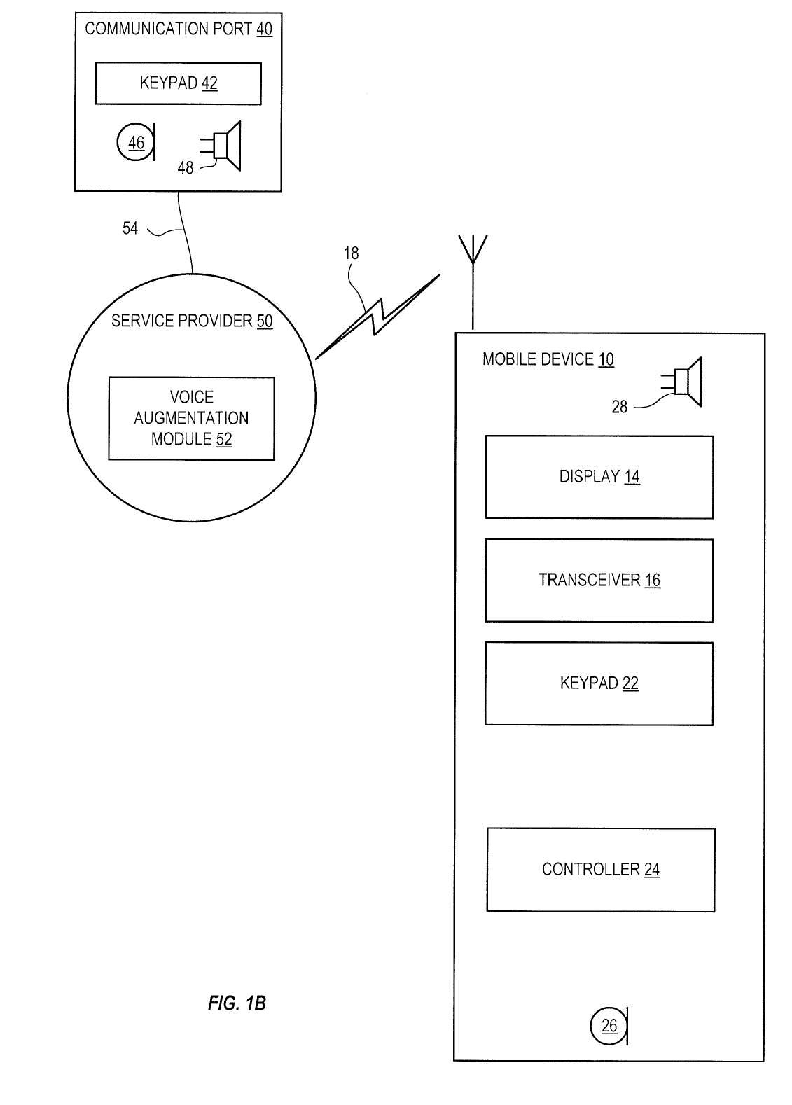

FIG. 2 is a flowchart illustrating one exemplary process 200 for activation 202 of, and then operation 204 (shown in dashed outline) by, voice augmentation module 12 of mobile device 10, FIG. 1A. Process 200 is for example implemented within controller 24 of mobile device 10. Activation 202 is for example initiated by command using keypad 22. In another example, activation of voice augmentation module 12 is initiated by command using keypad 42 of communication port 40, which causes signals to be communicated to mobile device 10 within data 18; these signals are interpreted as commands by controller 24 to activate voice augmentation module 12.

Operation 204 of voice augmentation module 12 is now described. As shown, voice augmentation module 12 is implemented as software or firmware of controller 24. In another embodiment, voice augmentation module 12 is for example software running within mobile device 10, for example operationally coupled to controller 24. In another embodiment, voice augmentation module 12 includes logical devices and software within mobile device 10 to provide functions discussed herein. In another embodiment, voice augmentation module 12 is an application loaded into memory 32 and executed by processor 30.

Once activated 202, voice augmentation module 12 determines 206 whether to augment (i.e., change, modify, replace) voice data generated by the user of mobile device 10 speaking into microphone 26 and/or to augment voice data generated by person(s) at communication port 40 speaking into microphone 46. In an example of decision 206, mobile device 10 (e.g., via controller 24) processes commands from keypad 22 and/or 42 so that voice augmentation module 12 determines which keys were pressed (different keys are for example programmed to command different actions) to then determine how to process 208 voice data. Step 208A provides specific algorithms or procedures used to augment voice data originating from mobile device 10; step 208B provides specific algorithms or procedures used to augment voice data originating from communication port 40.

As an example of processing voice data to remove background noises, a background noise suppression or removal algorithm may be employed. See, e.g., An Algorithm to Remove Noise from Audio Signal by Noise Subtraction, Springer Netherlands (Aug., 2008). See also algorithms employed by Polycom Soundstation VTX1000. Further examples of augmenting voice data by voice augmentation software include language to language augmentation, see, e.g., SRI. international algorithms, www.speech.sri.com and http://verbmobil.dfki.de/ww.html.

In an embodiment, voice augmentation module 12 includes speech recognition software and a speech synthesizer, which (a) recognizes and interprets a human voice and then (b) converts that voice to another voice (e.g., another language, another tone, a female or male voice, and/or a computer voice like the Star Trek® on-board computer). See, e.g., http://msdn.microsoft.com/en-us/magazine/cc163663.aspx.

Once voice data from mobile device 10 is processed 208A, augmented voice data 18 is transmitted 210A to communication port 40, to be played via speaker 48. Once voice data from communication port 40 is processed 208B, augmented voice data 18 is transmitted 210B to device 10 to be played via speaker 28.

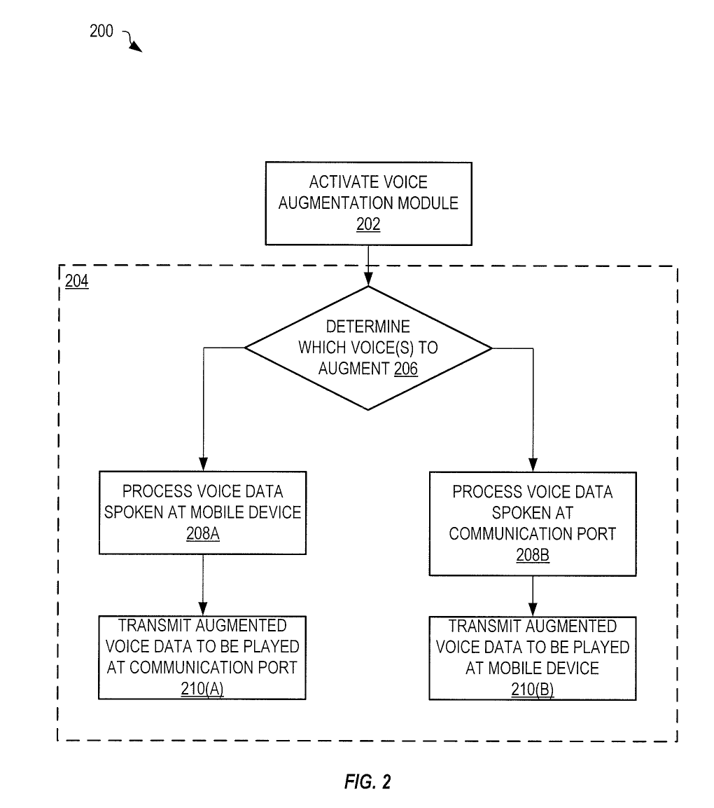

FIG. 3 shows one mobile device 300 with a datalog module 302. Mobile device 300 may represent one or more of a mobile phone, a Smartphone, a reader device (e.g., a Kindle device or iPad device), a mobile computer (e.g., a laptop computer), and other such devices that have communication capability, such as one or more of voice data, SMS data, and Internet traffic. Mobile device 300 is also shown with a (a) digital camera 304, which captures images or video of scenes around mobile device 300, (b) a transceiver 306, which facilitates wireless communications 308 (e.g., multimedia data and/or voice data) between mobile device 300 and a control center 350 (e.g., a server that is accessible by an authorized party over the Internet, as described further below; control center 350 may also be in or part of a mobile phone service provider operator or network), (c) a recognition module 322, which (in one embodiment) interprets sound heard by an on-board microphone 326 to detect a voice command that activates datalog module 302, as described below, and (d) a controller 324, which provides overall control and functioning of mobile device 300. As noted, microphone 326 captures sound (e.g., voice) input from a user of mobile device 300 (this voice input is converted to voice data 308 communicated to control center 350); a speaker 328 is also illustratively shown and provides audible output (e.g., voice data 308 (e.g., from an outside caller) to the user). A GPS receiver 329 may be included with mobile device 300 to provide current location.

In an embodiment, recognition module 322 is programmed to identify a voice command spoken into microphone 326. A voice command may for example be the word “help”. When the voice command is detected, datalog module 302 is activated and immediately instructs mobile device 300 to (i) capture as much voice and multimedia data as possible through microphone 326 and digital camera 304 and (ii) off-load this voice and multimedia data as wireless communications 308 as soon as possible, for storage within a data storage 352 (e.g., memory or disk space) at control center 350. If GPS 329 is present in mobile device 300, a current location of mobile device 300 may also be transmitted to control center 350, to associate location of mobile device 300 with off-loaded data stored within data storage 352.

In an alternate embodiment, recognition module 322 also monitors a keypad 303 of mobile device 300 for a defined key combination and/or sequence that activated datalog module 302. That is, operation of datalog module 302 may also be activated from keypad 303.

In an example of operation, a child carries mobile device 300 and a man (e.g., child molester) attempts to kidnap or assault the child. The child recognizes the danger and yells “help”, at which point mobile device 300 captures data in the form of (a) images (through operation of on-board digital camera 304) and (b) sounds (by digitizing sound from detected by microphone 326) and immediately transmits that data to control center 350. The man will likely attempt to destroy or throw mobile device 300 away, but by this point a certain amount of data (e.g., images of the man and/or voices from the man) are already downloaded to control center 350. In one embodiment, mobile device 300 will not turn off once activated by “help” (in this example); that is, even if the power button is pressed, the phone will not turn off for safety purposes (i.e., to release more data to storage 352). Further, the child may be able to provide identifying data about the man, for example saying “help, Mr. Z is taking me”; this identifying data is also captured and transmitted to control center 350. If GPS 329 is included, data 308 transmitted to control center 350 may include location information, which may further assist in identifying suspects (e.g., if a man kidnaps a child near a department store, perhaps the department store security systems can provide additional detail about the man; the location information from GPS 329 can be used to determine proximity of locations like the department store).

Data sent to control center 350 is for example stored in data storage 352; and this data may be accessed by authorized persons (e.g., police, parents), typically with appropriate passwords. Access is for example provided over an Internet connection 354 to control center 350 and through a data review device 356 (e.g., a computer or Smartphone). In this way, a parent or the police may quickly access and attempt to find useful information recorded about abduction of the child, which may save the child's life.

If mobile device 300 does not have a digital camera 304, voice data may still be recorded and transmitted to control center 350 as useful information in a similar way. If camera 304 is available, multimedia image data taken from cell phone camera may include still images and/or video (avi) data.

In an embodiment, datalog module 302 may be activated from control center 350 and/or data review device 356, via wireless communication 308, whereupon datalog module operates collect and send multimedia data to control center 350, as described above. For example, if a child carrying mobile device 300 becomes lost, datalog module 302 may be remotely activated from control center 350 to capture and send multimedia data sensed by mobile device 300, thereby providing information on the child's current location and circumstance.

In an embodiment, mobile device 300 is built into a garment worn by an individual (e.g., a child), such as one or more of a coat and a shoe. Mobile device 300 may then be less obvious to an attacker and may remain operational for longer than a device in the form of a mobile phone.

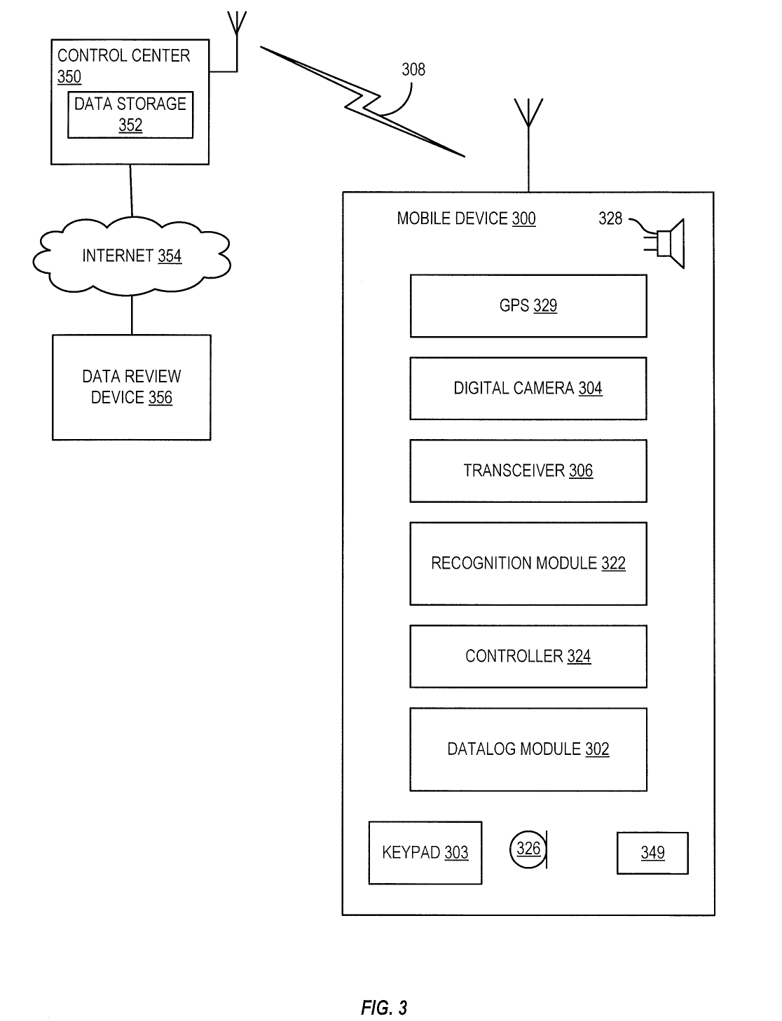

FIG. 4 is a flowchart illustrating one exemplary process 400 for operating mobile device 300. Process 400 may be implemented within controller 324 of mobile device 300, FIG. 3, for example in cooperation with recognition module 322. In step 402, voice data is sampled to detect a voice command preprogrammed into mobile device 300. In an example of step 402, recognition module 322 monitors audio detected by microphone 326 to detect a voice command (e.g., “HELP”). Step 404 is a decision. If, in step 404, no voice command is detected, mobile device 300 continues to operate as normal. Steps 402 and 404 repeat and may be considered a background process 406 of mobile device 300.

If, in step 404, a voice command is detected, mobile device 300 switches to a collect and off-load mode 407 (indicated by dashed outline) wherein a data communication channel is immediately requested 408 and multimedia data is captured 412 and stored within mobile device 300 via datalog module 302. For example, it may take several seconds for mobile device 300 to switch to an available data channel of a nearby cell tower. Process 400 waits for the data communication channel to open (410) and continually captures multimedia data (412). Once a data communication channel opens, captured multimedia data is off-loaded from mobile device 300 by transmission (414) via the open data communication channel to a remote server such as control center 350. Process 400 continues to transmit (416) and optionally capture (418) multimedia data to the remote server. That is, within mode 407, images, voice and/or video data are captured through available devices of mobile device 300 (such as through digital camera 304 and/or microphone 326) and transmitted (off-loaded as wireless data 308) to a remote location (e.g., to control center 350) by process 400. If GPS 329 is available, location information is also transmitted in mode 407 (e.g., at steps 414, 416).

In an embodiment, data is captured and off-loaded (mode 407 of process 400) from mobile device 300 within a short time period such as five seconds or less. Five seconds is enough time for the child to yell “help” (as a voice command) and for mobile device 300 to capture and send (a) location information if available from GPS 329, (b) at least one image from digital camera 304, and (c) identifying information (e.g., “Mr. Z has me”), detected by microphone 326. Mobile device 300 may be configured to provide continuous capture of data and transmission of that data within blocks (e.g., each block is 1 second in duration of data) until mobile device 300 is destroyed or turned off (but, again, in one embodiment, “turn off” capability of device 300 is disabled during mode 407 to better capture data to control center 350). Although data may be transmitted within 1 second blocks, these blocks are assembled at control center 350 and the original data is reconstructed. That is, the words “Mr. Z has me” may take 2 seconds to say and is captured and transmitted as sequential one second blocks as wireless data 308. These blocks are then recombined at control center 350 so that a reviewer at data review device 356 still hears “Mr. Z has me”, as captured by mobile device 300.

In one embodiment, as noted, mode 407 includes additional steps such as prohibiting “power off” of mobile device 300, so that data may be captured and transmitted to control center 350 until mobile device 300 is destroyed, which may permit many more seconds of information to be transmitted to control center 350 once triggered by a person in trouble yelling the voice command.

In another embodiment, recognition module 322 may be programmed to activate datalog module 302 on the occurrence of other events, to cause capture and off-load of data, as shown in process 400. In one example, recognition module 322 is programmed to activate datalog module 302 when (a) any unknown voices are heard, (b) a gunshot is detected, and/or (c) mobile device 300 is dropped (mobile device 300 may include a sensor 349 (FIG. 3) in the form of an accelerometer for this purpose).

In one embodiment, location of mobile device 300 is determined by mobile network computers which triangulate on mobile device 300 when datalog module 302 is activated. For example, assume that control center 350 is part of the mobile network (e.g., Verizon wireless) which runs data for mobile device 300. Once triangulation is determined, that information is stored as part of data off-loaded from mobile device 300, so that it may be used to help locate the user of mobile device 300. This embodiment is for example useful if mobile device 300 does not have GPS 329.

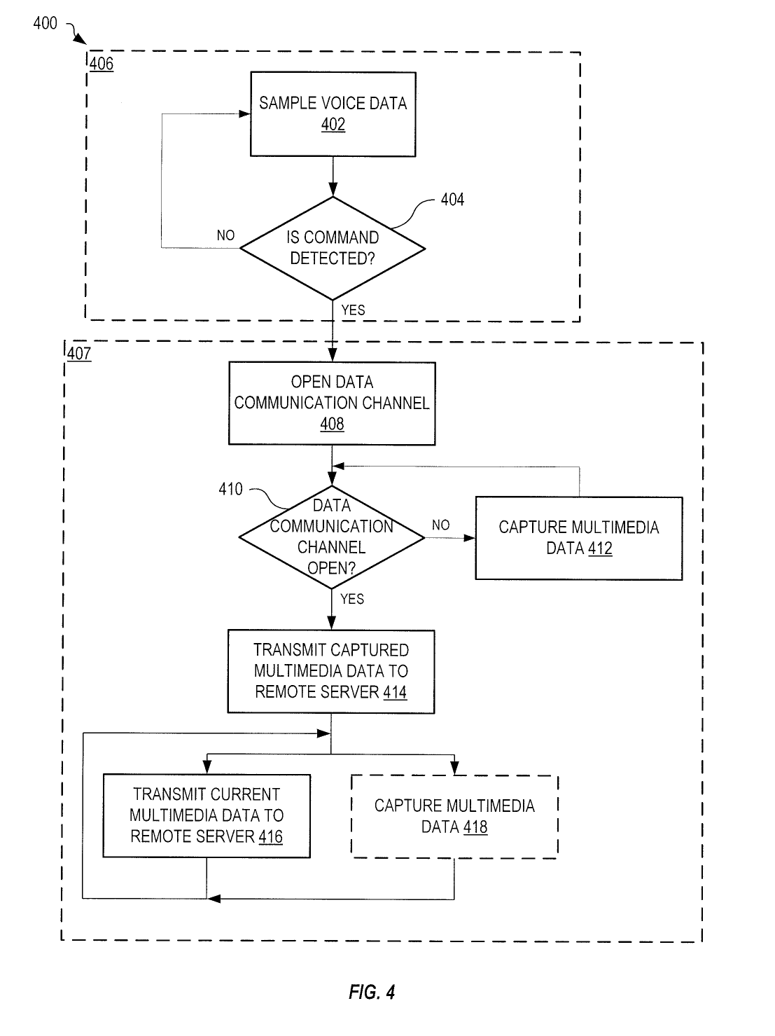

FIG. 5 shows one mobile device 500 with a motion module 502 which prohibits operation (SMS texting and/or phone calls) of mobile device 500 under certain circumstances described below. Mobile device 500 may represent one or more of a mobile phone, a Smartphone, a reader device, a mobile computer (e.g., a laptop computer), and other such devices that have communication capability. Mobile device 500 is also shown with a (a) keypad 504, which provides a user interface for mobile device 500, (b) a transceiver 506, which facilitates wireless communication 508 (e.g., multimedia data and/or voice data) between mobile device 500 and remote phones and data centers (collectively represented by network provider 550), and (c) a controller 510, which provides overall control and functioning of mobile device 500. Network provider 550 is accessible by an authorized party over the Internet 554, through a data control device 556 (e.g., a computer or Smartphone), to selectively activate motion module 502. Microphone 526 captures sound (e.g., voice) input from a user of mobile device 500 (this voice input is converted to voice data over wireless communication 508 to network provider 550); a speaker 528 is also illustratively shown and provides audible output (e.g., voice data over wireless communication 508 (e.g., from an outside caller through network provider 550) to the user.

Operationally, and in one embodiment, motion module 502 senses motion of mobile device 500 and compares actual motion to a threshold motion 509, and prohibits operation (SMS texting, e-mail, and/or phone calls) of mobile device 500 when exceeding threshold motion 509. Threshold motion 509 is for example 20 or 30 miles per hour, which generally indicates motion by a vehicle (e.g., car, truck). Motion module 502 in this embodiment has, for example, a GPS sensor or other motion sensor (e.g., accelerometer) which provides on-board information that permits determination of threshold motion 509. Threshold motion 509 may be set by a remote user (e.g., a parent) operating a data control device 556, which then sets threshold motion 509 through wireless communication 508 and within mobile device 500 (as such, the parent can for example increase threshold motion 509 to 50 mph or lower it to 10 mph, for example).

In one embodiment, motion module 502 is a GPS sensor and controller 510 automatically determines if mobile device 500 is in a driver position in a vehicle or in a passenger position. Specifically, by reviewing motion of mobile device in comparison to a known route (e.g., a highway), actual position may be closely determined to resolve whether a driver or passenger is using mobile device 500, thus disabling use of mobile device 500 when driver uses device 500 (and the vehicle is moving more than set threshold motion 509, but not disabling device 500 if the passenger uses device 500 even if threshold motion 509 is exceeded.

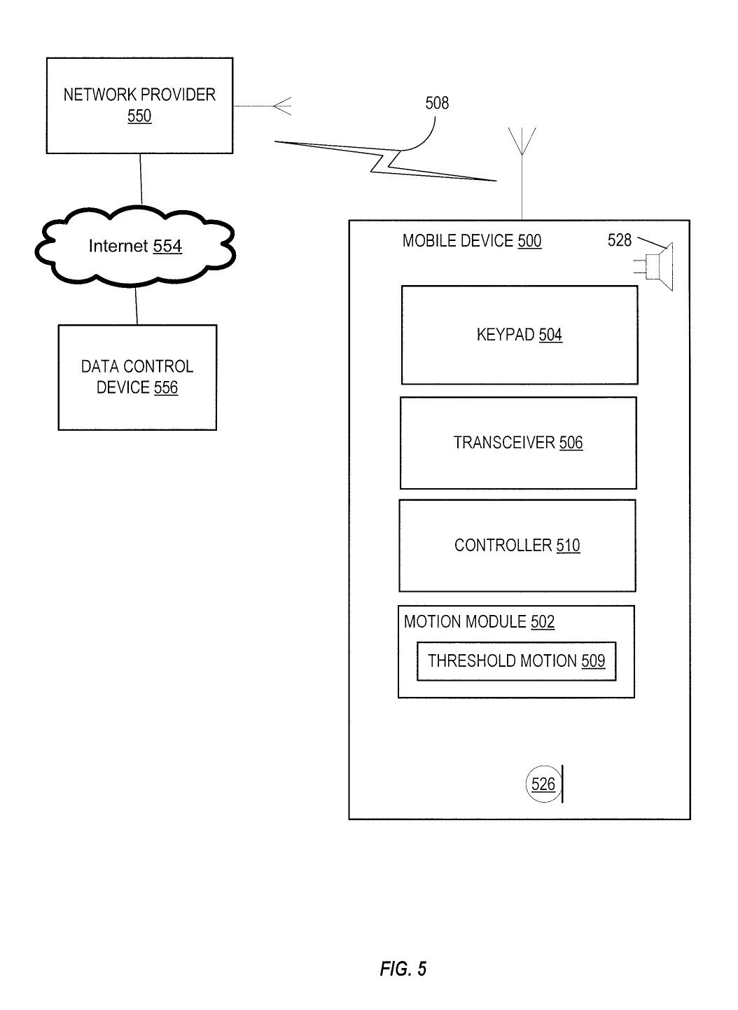

FIG. 6 shows a flowchart illustrating one exemplary process 600 for operating mobile device 500. Motion is sensed 602 and compared 604 to threshold motion. In an example of step 602, motion module 502 has a GPS which, over time, is used to determine speed of motion of mobile device 500. In an example of step 604, controller 510 compares actual motion of mobile device 500 with threshold motion 509. If threshold motion is exceeded (606), then select operations (e.g., SMS text messaging and/or voice communications) of device 500 are prohibited in step 608. In an example of step 608, controller 510 and motion module 502 cooperate to terminate communications through transceiver 506.

Accordingly, mobile device 500 is useful to prevent teenagers from text messaging or using a cell phone when operating a vehicle. As noted, if mobile device 500 has a GPS sensor, motion module 502 may further detect whether a person sits in the passenger seat or driver seat by differentiating GPS data over time (which can have accuracy to one meter or less) so that mobile device 500 is still usable by a passenger but not a driver of an automobile, in an embodiment.

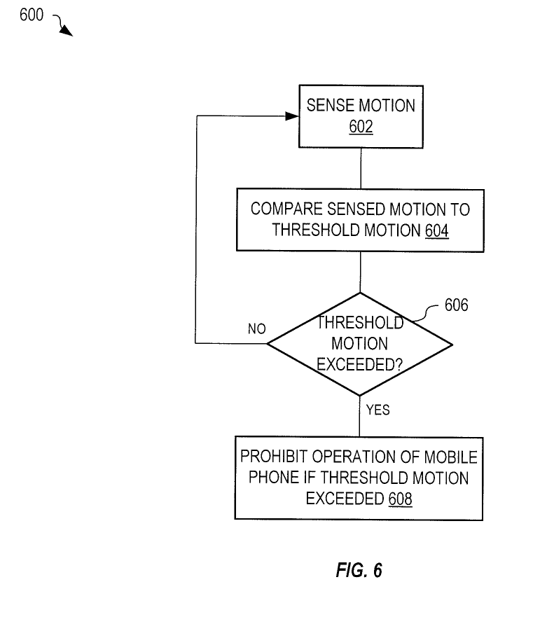

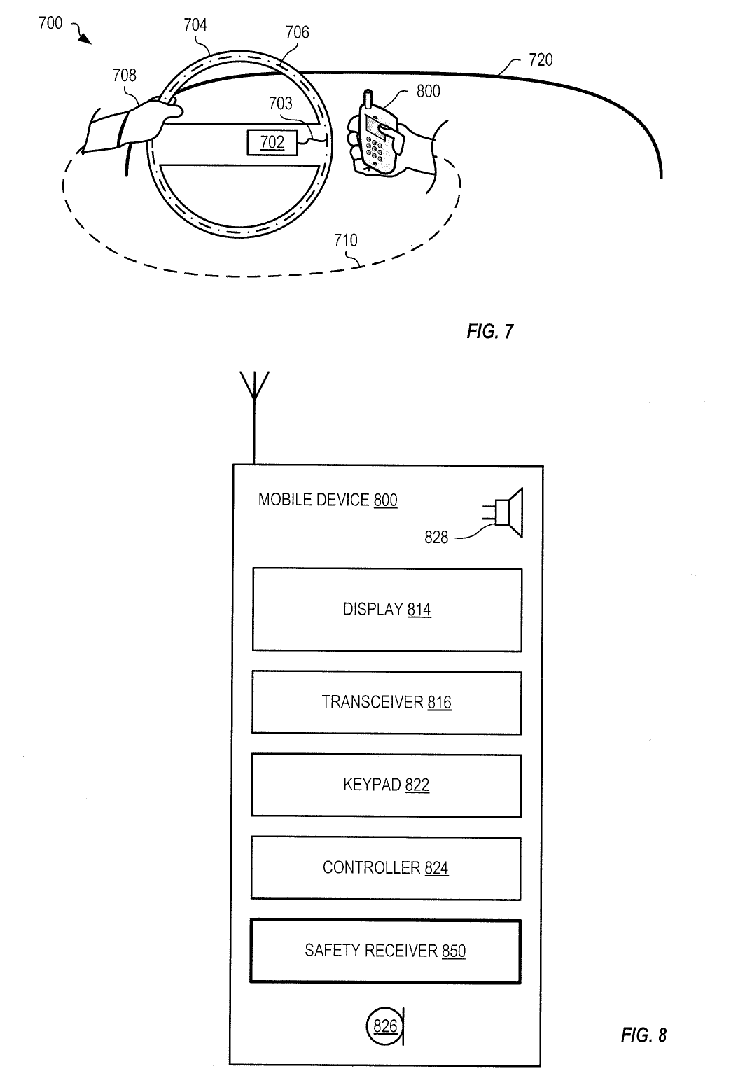

FIG. 7 shows one exemplary system 700 for disabling operation of a mobile device 800 while driving a vehicle 720. FIG. 8 shows mobile device 800 of FIG. 7 with a safety receiver 850. FIGS. 7 and 8 are best viewed together with the following description. Mobile device 800 may represent one or more of a mobile phone, a Smartphone, a reader device, a mobile computer (e.g., a laptop computer), and other such devices that have communication capability.

Within system 700, a transmitter 702 connects to an antenna 706 within steering wheel 704 of vehicle 720. In an embodiment, antenna 706 is formed by metal within the structure of steering wheel 704. While driving vehicle 720, the driver has one hand 708 in contact with steering wheel 704 and attempts to operate mobile device 800 with his other hand.

Transmitter 702 generates a disabling signal 703 (e.g., at a particularly frequency) that transmits through the human body better than it does through air. Mobile device 800 includes a display 814, a transceiver 816, a keypad 822, a controller 824, and a safety receiver 850. Safety receiver 850 is tuned to detect the signal from transmitter 702; however, it cannot normally detect disabling signal 703 since it does not transmit over great distances through air. When the driver is touching steering wheel 704, and is thereby proximate to antenna 706, hand 708 picks up disabling signal 703 from transmitter 702, and since disabling signal 703 travels better through the human body than through air, the driver's body makes a conductive path 710 for the disabling signal from antenna 706 to safety receiver 850 within mobile device 800.

Upon detecting disabling signal 703 from transmitter 702, safety receiver 850 disables operation of mobile device 800, such as by cooperation with controller 824 and/or transceiver 816. In an embodiment, display 814 is disabled by safety receiver 850 when disabling signal 703 from transmitter 702 is detected. Since other occupants of vehicle 720 are not in contact with steering wheel 704, their mobile devices are not disabled. Disabling signal 703 from transmitter 702 may include information (e.g., a special code) to prevent false disabling of mobile device 800 by stray transmissions from other sources at similar frequencies.

In an embodiment, safety receiver 850 includes a timer that, once disabling signal 703 is no longer received, delays reactivation of disabled functionality of mobile device 800 for a defined period, such as three minutes. This prevents the driver from attempting to use mobile device 800 while at a stop light or junction.

In an embodiment, transmitter 702 is in communication with a speedometer of vehicle 720 and generates disabling signal 703 only when vehicle 720 is in motion. Alternatively, transmitter 702 (or the associated vehicle) includes a GPS device for detecting motion of the vehicle. System 700 is suitable for controlling use of mobile device 800 within other vehicles, such as trains, aircraft, motorcycles, etc.

In an alternate embodiment, transmitter 702 and antenna 706 generate a close field transmission proximate to steering wheel 704 that has a range of between two and three feet. Since the driver sits within this close field transmission, safety receiver 850 detects the signal from transmitter 702 and thereby disables operation of mobile device 800 within this area.

Safety receiver 850 within mobile device 800 may have other utilization in areas where operation of mobile device 800 is not permitted, such as within a theater and a hospital. Such areas may include a transmitter that broadcasts disabling signal 703, thereby disabling operation of any mobile devices (e.g., mobile device 800) within range of the transmitter.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A mobile device, comprising:
a microphone;
a digital camera;
a voice recognition module for determining whether a voice command is spoken into the microphone; and
a datalog module for capturing and off-loading multimedia data from the microphone and digital camera when activated by the voice command.

2. The mobile device of claim 1, the multimedia data comprising one or more of image data from the digital camera, video data from the digital camera, and voice data from the microphone.

3. The mobile device of claim 1, wherein a control center remotely stores the multimedia data for remote access and review by and through the Internet.

4. The mobile device of claim 3, further comprising a GPS sensor integrated with the mobile device, the datalog module further capturing and off-loading location information from the GPS sensor as part of the multimedia data stored at the control center.

5. The mobile device of claim 1, wherein turn-off of the mobile device is prohibited when the datalog module is activated.

6. A mobile device, comprising:
a sensor for generating a trigger; and
a datalog module which, when triggered, captures multimedia data at the mobile device and transmits the multimedia data through cell networks to a control center.

7. The mobile device of claim 6, the sensor comprising an accelerometer, the multimedia data comprising one or more of voice data, image data, video data and GPS location.

8. The mobile device of claim 6, further comprising means for disabling power off functionality of the mobile device when the datalog module is activated.

9. The mobile device of claim 6, further comprising an accelerometer which triggers activation of the datalog module independently from a voice command.

10. The mobile device of claim 6, wherein turn-off of the mobile device is prohibited when the datalog module is triggered.

11. A system for augmenting safety of a user of a mobile device, comprising:
a mobile device having a microphone and one or more of a GPS sensor and a digital camera;
a datalog module activated by voice or a trigger to capture data from the microphone, the GPS sensor and the digital camera, the data being wirelessly offloaded from the mobile device; and
remote data storage accessible through the Internet to review the data.

12. The system of claim 11, wherein the mobile device comprises a recognition module which recognizes a voice command through the microphone or a trigger from movement of the accelerometer.

13. A mobile device, comprising:
a motion module which, when activated at the mobile device or through a cell network, disables communications through the mobile device when the mobile device is in motion.

14. The mobile device of claim 13, further comprising a GPS sensor and controller, the controller determining whether the mobile device is in a driver position on a road and disabling the communications if the mobile device is in the driver position and in motion.

15. The mobile device of claim 13, the motion module disabling communications when the mobile device exceeds a threshold motion that is preset in the mobile device or set through the cell network.

16. The mobile device of claim 13, wherein said communications comprise one of voice data, SMS data, Internet traffic.

17. A mobile device, comprising:
a microphone; and
a voice augmentation module which is selectively activated to augment voice data spoken into the mobile device, by (a) removing background noise and/or to (b) replacing or changing voice data.

18. The mobile device of claim 17, further comprising voice recognition software and voice synthesis software to replace or change the voice data.

20. The mobile device of claim 17, wherein the voice augmentation module is activated from the mobile device.

21. The mobile device of claim 17, wherein the voice augmentation module is activated from a remote communication port.

22. A system for augmenting voice communication between a mobile device and a communication port, comprising:
a voice augmentation module located within a service provider of the mobile device that is selectively activated to augment voice data spoken into the mobile device, by (a) removing background noise and/or to (b) replacing or changing voice data.

23. The system of claim 22, wherein the voice augmentation modules is selectively activated from one of the mobile device and the communication port.

24. A system for disabling operation of a mobile device by an operator of a vehicle, comprising:
a transmitter within the vehicle for generating a disabling signal;
an antenna coupled with the transmitter for transmitting the disabling signal proximate the operator of the vehicle; and
a safety receiver within the mobile device for receiving the disabling signal and disabling, at least in part, operation of the mobile device.

25. The system of claim 24, wherein a safety receiver within the mobile device receives the disabling signal when the operator of the vehicle touches a control of the vehicle and the mobile device simultaneously.

26. The system of claim 25, wherein the control of the vehicle is the steering wheel of an automobile.

27. The system of claim 25, wherein the control of the vehicle is a power lever of a train.

28. A mobile device, comprising:
a microphone and at least one additional device selected from the group of a digital camera and a GPS sensor; and
a datalog module which, when activated, captures data from the microphone and additional device and off-loads the data to remote data storage.

29. The device of claim 28, wherein the datalog module is activated by one of (a) determining that the mobile device was dropped, (b) a voice command determined through voice recognition and (c) a keypad selection.
